(19) United States
(12) Patent Application Publication
(10) Pub. No.: US 2026/0089266 A1
(43) Pub. Date: Mar. 26, 2026

(54) SYSTEMS AND METHODS FOR INTELLIGENT IN-APP CALLING

(71) Applicant: Wells Fargo Bank, N.A., San Francisco, CA (US)

(72) Inventors: Krishna K. Sabbu, Hyderabad (IN); Ramya Balasubramanian, Secunderabad (IN); Christopher Gaston Seagram, Austin, TX (US); John Andrew Chuprevich, Davidson, NC (US); Matthew N. Wheeler, Charlotte, NC (US); Serkan Gunpinar, Dallas, TX (US); Shayan Mukherjee, Charlotte, NC (US); Roxane S. Whalen, Portland, OR (US); Ethan Mark, San Francisco, CA (US); Gulshan Kumar, Bangalore (IN)

(21) Appl. No.: 18/898,351

(22) Filed: Sep. 26, 2024

(51) Int. Cl. H04M 7/00; H04L 65/1069

(52) U.S. Cl. CPC H04M 7/006; H04L 65/1069

(57) ABSTRACT

Systems, apparatuses, methods, and computer program products are disclosed for intelligent in-application calling. An example method includes receiving, from a user device, a user authentication request comprising authentication data associated with a user and determining, based on the authentication data, a user authentication result. The example method further includes establishing an authenticated session with the user and generating a user activity log. The example method further includes receiving a voice over internet protocol (VoIP) request during the authenticated session and determining an agent device to connect with the user. The example method further includes establishing a VoIP call between the user device and the agent device.

### BACKGROUND

Customers across various industries frequently seek customer support by contacting (e.g., calling) a call center. Customers can provide numerous responses to call center prompts in order to navigate the call center system to resolve their inquiry.

### BRIEF SUMMARY

Call centers provide an accessible resource that customers may utilize (e.g., contact via a phone call) to seek assistance to resolve various issues that customers may encounter (e.g., technical support, general inquiries, account registration, and/or the like), obtain information (e.g., account information, a solution to a particular issue, or the like), or the like. Thus, call centers are a valuable resource for entities and their respective customers. As such, call centers are now ubiquitous in society, and therefore it is necessary for entities in all industries to implement call centers that are equipped to resolve a variety of customer queries. To do so, call centers frequently implement standardized interaction techniques (e.g., interactive voice response (IVR) systems, standardized scripts for employees, or the like) that allow a call center (e.g., the call center employees) to provide consistent assistance for a variety of different types of customer queries (e.g., technical issues, billing issues, account management, or the like). However, while standardized interaction techniques enable global support for an entity's customers, they expose both the entities associated with call centers and their respective customers to unique risks given the lack of customer personalization involved in standardized interaction techniques. In this regard, thoughtful (e.g., personalized) routing techniques are required to ensure the security and efficiency of customer query resolutions provided by a call center.

Traditionally, to manage a variety of different types of customer queries, a call center may implement an IVR menu that is designed to categorize and direct calls, based on a set of rules and user input, to an appropriate department that is best suited to resolve a particular customer query. However, a singular IVR menu is often not sufficient to handle the complexity and diversity of the variety of different types of customer queries. Thus, to provide global support for a variety of different types of customer queries, a call center may implement multiple IVR menus. In this regard, each subsequent menu may provide increasingly specific questions to the user until the system may confidently determine a destination to route the customer call (e.g., a particular department, a particular agent, or the like). For example, assume a customer calls a call center to seek assistance for a technical issue associated with paying a bill. First, the customer may reach a first IVR menu that presents the following options: to make a payment, press 1; to check your account balance, press 2; to update your billing information, press 3; for billing disputes, press 4; and for technical support press 5. Assume the customer presses the number 5 on their mobile device. This action may trigger the customer call to be routed to a subsequent IVR menu that presents the following options to the customer: for internet issues, press 1; for phone issues, press 2; for television issues, press 3; and for billing issues, press 4. To this end, the customer may press the button 4 on their mobile device, which may ultimately route the customer to an employee that specializes in technical billing queries.

While IVR menus may eventually direct a customer to a call center employee, IVR menus have many blind spots that limit their capabilities. In particular, since IVR menus merely rely upon predefined rules to direct customer calls to particular departments/employees or subsequent IVR menus, they are incapable of considering context-specific nuances or situations that are not adequately covered by their predefined rules, and thus may frequently route customers to incorrect call destinations. For example, a customer may navigate through multiple IVR menus, but may not be presented with an option that adequately describes the customer's particular issue that they wish to resolve.

Moreover, IVR menus present a variety of security concerns for both the customer and the entity associated with the IVR menu. For example, a bad actor may impersonate a legitimate customer to illegally obtain unauthorized data (e.g., a customer's account number, personal identifiable information (PII), or the like). To increase the security associated with a customer call to a call center, entities may implement and perform customer authentication operations during the customer call. In this regard, an IVR menu that ultimately causes the presentation of PII to the caller may only be presented to the caller after the caller successfully completes an authentication operation. For example, the call center may request that a user provides customer authentication data (e.g., customer account number, social security number, or the like) via the customer's device that is participating in the call. However, a customer's authentication data or authentication result (e.g., verified or not verified) is not stored or passed from a first IVR menu to a subsequent call routing destination (e.g., second IVR menu or call center agent). Thus, customer's may be required to frequently input authentication information (e.g., via a computing device) throughout the duration of a customer call. And while frequent customer authentication may allow for the call center to trust the legitimacy of the caller, callers lack access to a method that enables authentication of the call center. As a result, a customer that wishes to call a call center to assist with resolving a particular issue is vulnerable to a bad actor that alleges that they are associated with the call center to ultimately obtain PII associated with the customer.

The inherent blind spots and limitations associated with providing an intelligent in-application calling system presents a technical problem. As such, a need exists for a solution that (i) efficiently and accurately routes customer calls to an appropriate destination in real-time and (ii) securely authenticates the participants that participate in a customer call (e.g., the customer and an agent associated with the call center). Example embodiments provide a technical solution to this technical problem because example embodiments do not require manual intervention. Further, by leveraging a user activity log that is continuously updated throughout an authenticated session and establishing a voice over internet protocol (VoIP) call during the authenticated session, example embodiments provide a technical solution that streamlines call routing processes, bolsters trust between a customer and an agent, and enhances security for the participants of the VoIP call.

Example embodiments described herein mitigate the above concerns by creating and using a centralized system that leverages in-application calling and a user activity log to provide secure and efficient user call routing for the duration of the VoIP call. To do so, example embodiments may receive a user authentication request from a user device. The user authentication request may be an electronic request that comprises authentication information about a user, such as a username and password, a personal identification number (PIN), biometric data, a one-time password, and/or the like. Example embodiments may then determine, based on the authentication information, a user authentication result by comparing the received authentication information to stored authentication information associated with the user. In response to a successful user authentication result, example embodiments may establish an authentication session with the user.

Example embodiments may then generate a user activity log during the authenticated session. The user activity log may be a data construct that comprises a detailed record of actions performed by the user during the established authenticated session. For example, the user activity log may record particular actions, such as page visits, file uploads and/or attempted file uploads, data modifications and/or attempted data modifications, transactions and/or attempted transactions, user interaction data (e.g., mouse clicks, keyboard clicks, or the like), and/or the like. In addition, each recorded action may be associated with a corresponding action parameter set that includes a one or more parameters associated with the action. For example, a corresponding action parameter set may include a timestamp (e.g., the time/date the action was performed), location (e.g., the location of the user device that was used to perform the action), device information (e.g., a unique device ID associated with the user device, such as an international mobile equipment identity (IMEI) or medium access control (MAC) address, or the like), action outcome (e.g., an indication of whether the action was successfully or not successfully performed, such as successful or not successful, green or red, or some other type of categorical classification that indicates the action's outcome), and/or the like associated with each corresponding action that is recorded in the user activity log.

Example embodiments may then receive a VoIP request during the authentication session and from the user device. The VoIP request may comprise at least an indication of the user authentication result. Example embodiments may then determine an agent device to connect with user based on the VoIP request. To do so, example embodiments may leverage an intent determination model that determines a user intent parameter set based on the user activity log. Thereafter, the smart routing engine may determine a matched agent associated with the agent device based on the user intent parameter set. Example embodiments may leverage a matching machine learning model that uses the user intent parameters set to determine a matched agent.

Example embodiments may then establish a VoIP call between the user device and the agent device. To do so, example embodiments may generate a VoIP initiation request. The VoIP initiation request may be an electronic request that comprises one or more parameters that may be subsequently utilized by a VoIP provider to establish the VoIP call. Subsequently, example embodiments may provide the VoIP initiation request to a VoIP provider, such that the VoIP provider may establish the requested VoIP call based on the VoIP initiation request. Upon establishment of the VoIP call, example embodiments may (i) provide the user (e.g., a customer) with an indication that the agent is verified and (ii) provide the agent with an indication that the user is verified and/or provide the agent with context information (e.g., user demographic data, a predicted intent, or the like) pertaining to the user.

During the established VoIP call, example embodiments may receive a call update response that indicates an update associated with a particular VoIP call. Example embodiments may subsequently determine a call status based on the call update response that indicates the current state of the VoIP call (e.g., active call, call ended, or the like). Example embodiments may determine an action protocol based on the call update response. The action protocol may refer to one or more actions that may be performed in response to a trigger event (e.g., a particular call update response). Example embodiments may then cause performance of the action protocol.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates an example flowchart for providing intelligent in-application calling in accordance with some example embodiments described herein.

FIG. 4 illustrates an example flowchart for updating a user activity log, in accordance with some example embodiments described herein.

FIG. 5 illustrates an example flowchart for determining a matched agent, in accordance with some example embodiments described herein.

FIG. 6 illustrates another example flowchart for determining a security action, in accordance with some example embodiments described herein.

FIG. 7 illustrates another example flowchart for providing a VoIP initiation request to a VoIP provider, in accordance with some example embodiments described herein.

FIG. 8 illustrates another example flowchart for causing performance of an action protocol based on a VoIP call report, in accordance with some example embodiments described herein.

FIG. 9 illustrates another example flowchart for causing presentation of participant verification data on the user device and/or agent device, in accordance with some example embodiments described herein.

FIG. 10 illustrates another example flowchart for training the matching machine learning model based on a match quality indication, in accordance with some example embodiments described herein.

FIG. 11 illustrates a swim lane diagram with example operations that may be performed by components of the environment depicted in FIG. 1, in accordance with some example embodiments described herein.

FIG. 12 illustrates an example user interface used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

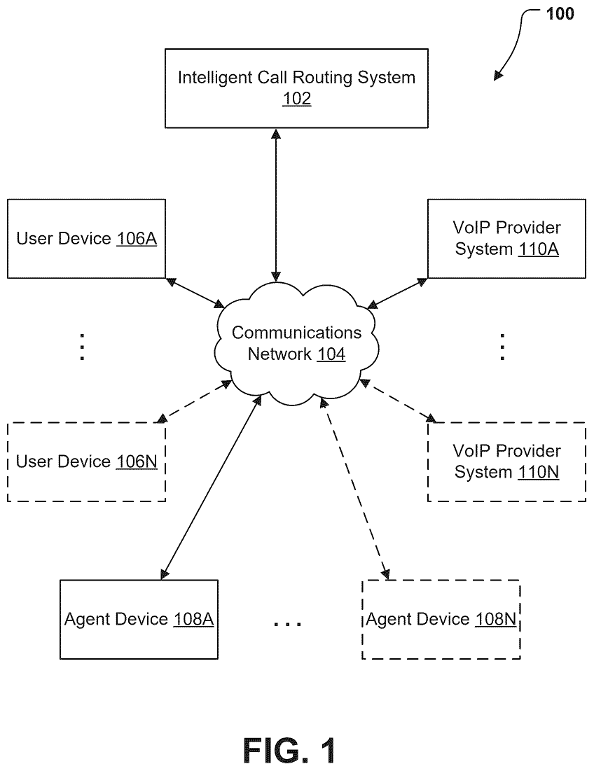

Example embodiments described herein may be implemented using any of a variety of computing devices or servers. To this end, FIG. 1 illustrates an example environment 100 within which various embodiments may operate. As illustrated, an intelligent call routing system 102 may receive and/or transmit information via communications network 104 (e.g., the Internet) with any number of other devices, such as one or more of user devices 106A-106N, agent devices 108A-108N, and/or VoIP provider systems 110A-110N.

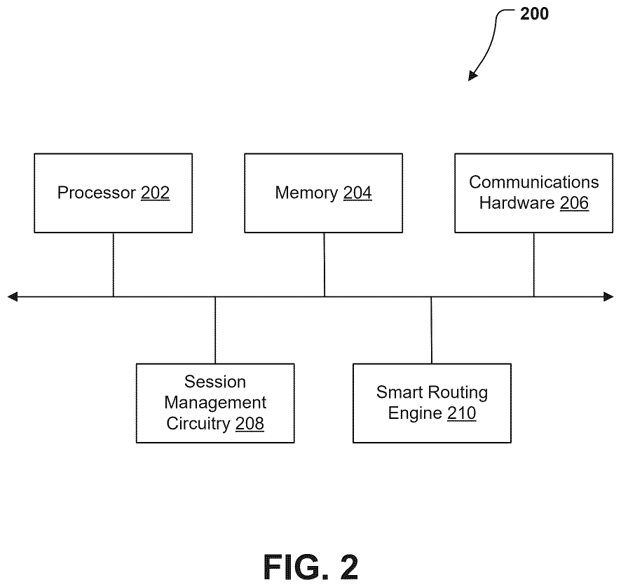

The intelligent call routing system 102 may be implemented as one or more computing devices or servers, which may be composed of a series of components. Particular components of the intelligent call routing system 102 are described in greater detail below with reference to apparatus 200 in connection with FIG. 2.

The one or more user devices 106A-106N, the one or more agent devices 108A-108N, and the one or more VoIP provider systems 110A-110B may be embodied by any computing devices known in the art. In some embodiments, a particular user (e.g., a customer) may be associated with the one or more user devices 106A-106N. Additionally, a particular agent (e.g., a call center employee) may be associated with one or more agent devices 108A-108N. Moreover, a particular VoIP provider may be associated with one or more VoIP provider systems 110A-110N. The one or more user devices 106A-106N, the one or more agent devices 108A-108N, and the one or more VoIP provider systems 110A-110N, need not themselves be independent devices, but may be peripheral devices communicatively coupled to other computing devices.

### Example Implementing Apparatuses

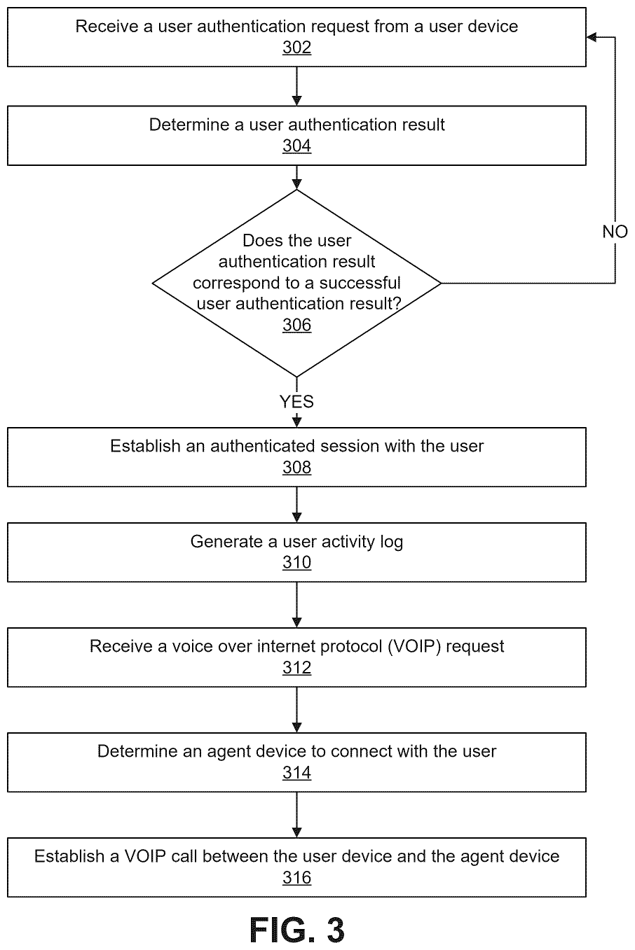

The intelligent call routing system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-10. As illustrated in FIG. 2, the apparatus 200 may include processor 202, memory 204, communications hardware 206, session management circuitry 208, and smart routing engine 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud”processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

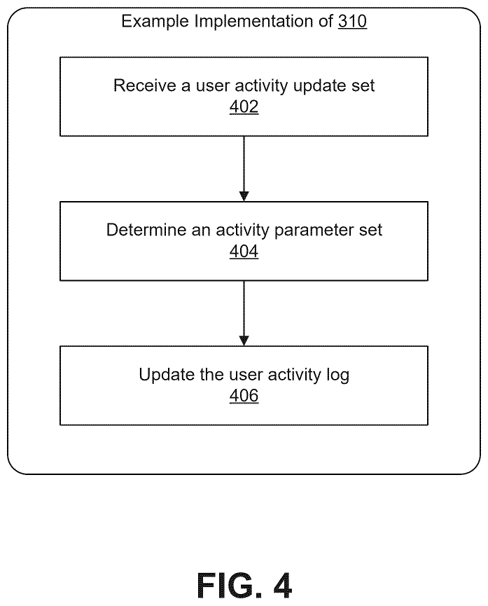

In addition, the apparatus 200 further comprises session management circuitry 208 that determines, based on authentication data, a user authentication result. In addition, session management circuitry 208 may establish an authenticated session with the user. The session management circuitry 208 may utilize processor 202, memory 204, or any other hardware component included in the apparatus 200 to perform these operations, as described in connection with FIGS. 3-4 below. The session management circuitry 208 may further utilize communications hardware 206 to gather data from a variety of sources (e.g., user device 106A through user device 106N, agent device 108A through agent device 108N, or VoIP provider system 110A through VoIP provider system 110N, as shown in FIG. 1), and/or exchange data with a user, and in some embodiments may utilize processor 202 and/or memory 204.

In addition, the apparatus 200 further comprises a smart routing engine 210 that determines an agent device to connect with the user. In addition, smart routing engine 210 may leverage an intent determination model to determine a user activity log and may leverage a matching machine learning model to determine a matched agent. Further, smart routing engine 210 may train the matching machine learning model based on data (e.g., a match quality indication) received from the agent device (e.g., agent device 108A, or the like) or the user device (e.g., user device 106A, or the like). The smart routing engine 210 may utilize processor 202, memory 204, or any other hardware component included in the apparatus 200 to perform these operations, as described in connection with FIGS. 3 and 5-10 below. The smart routing engine 210 may further utilize communications hardware 206 to gather data from a variety of sources (e.g., user device 106A through user device 106N, agent device 108A through agent device 108N, or VoIP provider system 110A through VoIP provider system 110N, as shown in FIG. 1), and/or exchange data with a user, and in some embodiments may utilize processor 202 and/or memory 204.

Although components 202-210 are described in part using functional language, it will be understood that the particular implementations necessarily include the use of particular hardware. It should also be understood that certain of these components 202-210 may include similar or common hardware. For example, the session management circuitry 208 and smart routing engine 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the session management circuitry 208 and smart routing engine 210 may leverage processor 202, memory 204, or communications hardware 206 as described above, it will be understood that any of session management circuitry 208 and smart routing engine 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that session management circuitry 208 and smart routing engine 210 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations

Turning to FIGS. 3-10, example flowcharts are illustrated that contain example operations implemented by example embodiments described herein. The operations illustrated in FIGS. 3-10 may, for example, be performed by the intelligent call routing system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, session management circuitry 208, smart routing engine 210, and/or any combination thereof. It will be understood that user interaction with the intelligent call routing system 102 may occur directly via communications hardware 206 or may instead be facilitated by a separate computing device (e.g., user device 106A-106N, agent device 108A-108N, VoIP provider system 110A-110N, or the like), as shown in FIG. 1, and which may have similar or equivalent physical componentry facilitating such user interaction.

Turning first to FIG. 3, example operations are shown for intelligent call routing.

As shown by operation 302, the apparatus 200 includes means, such as processor 202, memory 204, communications hardware 206, or the like, for receiving a user authentication request comprising authentication data associated with the user. In some embodiments, the user authentication request may be a request to access an associated user account maintained by apparatus 200. The authentication request may comprise one or more authentication factors associated with the particular user or the particular computing device that caused transmission of the user authentication request. For example, the one or more authentication factors may be a username and password, a PIN, biometric data, a one-time password, a device ID, such as an international mobile equipment identity (IMEI) or medium access control (MAC) address, an indication of a device model, geolocation data, or the like.

In some embodiments, the apparatus 200 (e.g., communications hardware 206) may receive the authentication request from a computing device (e.g., user device 106A) via a network (e.g., communications network 104, shown in FIG. 1). In some embodiments, communications hardware 206 may subsequently store the authentication request in a local storage device (e.g., memory 204, or the like). Additionally, or alternatively, communications hardware 206 may transmit the authentication request to session management circuitry 208 to enable real-time evaluation of the authentication request.

As shown by operation 304, the apparatus 200 includes means, such as processor 202, memory 204, session management circuitry 208, or the like, for determining a user authentication result. The user authentication result may indicate whether a user (e.g., the user that transmitted the user authentication request in operation 302) is authenticated or not authenticated based on the received authentication data provided in the user authentication request. For example, a user authentication result may be a categorical result of “authenticated” or “not authenticated”, a numerical value of 1 for an authenticated user or 0 for a non-authenticated user, a Boolean value of “true” for an authenticated user or “false” for a non-authenticated user, or the like. A user authentication result that corresponds to an authenticated user may indicate that there is a sufficient likelihood that the user that transmitted the user authentication request from a computing device (e.g., user device 106A, or the like) is who they allege they are. In this regard, the apparatus 200 (e.g., session management circuitry 208) may subsequently allow the user (e.g., via a computing device) to access a particular user account (e.g., the user account that the user requested to access in operations 302). Alternatively, a user authentication result that corresponds to a non-authenticated user may indicate that there is an insufficient likelihood that the user that transmitted the authentication request from a computing device is who they allege they are. In this regard, the apparatus 200 (e.g., session management circuitry 208) may deny the computing device associated with the user access to a particular user account.

In some embodiments, a local storage device, such as memory 204, may store baseline authentication data for each user associated with a user account that is maintained by the apparatus 200 and/or for each user that is registered for the intelligent in-application call routing service that is provided by intelligent call routing system 102. In this regard, session management circuitry 208 may retrieve the received user authentication request and the baseline authentication data associated with the user that allegedly transmitted the authentication request to the apparatus 200 (e.g., communications hardware 206) from a local storage device (e.g., memory 204, or the like). Subsequently, session management circuitry 208 may use any suitable method to evaluate the authenticity of each received authentication factor. In some embodiments, session management circuitry 208 may determine a partial authentication result for each received authentication factor. The partial authentication result may be a numerical score (e.g., a score between 0 and 1), a categorical result (verified or not verified, authenticated or not authenticated, or the like), and/or the like. For example, session management circuitry 208 may utilize an authentication factor evaluation set that may be stored in a local storage device, such as memory 204, to determine a partial authentication result for each received authentication factor. The authentication factor evaluation set may describe particular rules and/or conditions that session management circuitry 208 may utilize to determine how to evaluate each received authentication factor (e.g., the authentication factor evaluation set may describe a weight for each authentication factor, a similarity threshold to utilize while evaluating an authentication factor, or the like). For example, the authentication factor evaluation set may describe that a device ID authentication factor must exactly match a baseline authentication factor corresponding to the same device ID in order for session management circuitry 208 to determine a successful authentication result. In another example, the authentication factor evaluation set may describe that the geolocation of the computing device that transmitted the received user authentication request must be within a particular radius (e.g., 1 kilometer) of a particular location (e.g., the user's home address) in order for session management circuitry 208 to determine a successful authentication result. In yet another example, the authentication factor evaluation set may describe that fingerprint data may need to be 85% similar to baseline fingerprint data for the user.

In some embodiments, session management circuitry 208 may use any suitable method to combine the partial authentication results to ultimately determine a user authentication result. For example, session management circuitry 208 may calculate a weighted average of partial authentication scores where each authentication factor is weighted based on a weight that is indicated by the authentication factor evaluation set. Alternatively, session management circuitry 208 may use a trained machine learning model to combine each partial authentication result to ultimately determine an authentication result for the received user authentication request. For example, the machine learning model may be trained using a large training dataset comprising user authentication requests, which in turn comprises authentic and nonauthentic authentication factors that correspond to partial authentication results. As a result, through training, the machine learning model may learn weights for each authentication factor, and thus may utilize these learned weights to combine the partial authentication results that are determined for each received authentication factor.

As shown by operation 306, the apparatus 200 includes means, such as processor 202, memory 204, session management circuitry 208, or the like, for determining whether the user authentication result is a successful authentication result. In some embodiments, session management circuitry 208 may retrieve the user authentication result from a local storage device (e.g., memory 204, or the like) or from the trained machine learning model to determine whether the user authentication result is a successful authentication result. In response to determining a successful user authentication result, the procedure may advance to operation 308. Alternatively, in response to determining an unsuccessful user authentication result (e.g., in response to receiving incorrect or nonauthentic authentication data), the procedure may revert back to operation 302.

As shown by operation 308, the apparatus 200 includes means, such as processor 202, memory 204, communications hardware 206, session management circuitry 208, or the like, for establishing an authenticated session with the user. An authenticated session with the user may describe a period of time that a session token, which indicates that the user is authenticated with the apparatus 200 and may obtain protected data (e.g., user account data) that is otherwise protected, is active. In some embodiments, session management circuitry 208 may use any suitable method to generate a session token (e.g., a JSON Web Token (JWT). For example, session management circuitry 208 may (i) create a header that comprises metadata about the token (e.g., an indication of the type of generated token (e.g., JWT), a signing algorithm, such as Hash-based Message Authentication Code (HMAC) with SHA-256, and/or the like), (ii) create a payload that comprises user data and/or token data (e.g., information about the user, such as a user identifier, expiration time for the token, or the like), (iii) encode and combine the header and payload, such that the data may be securely utilized in uniform resource locators (URLs), and (iv) the combined header and payload may be signed using a secret key and signing algorithm, such that the signing creates a unique key based on the secret key and signing algorithm.

In response to the generation of the session token, session management circuitry 208 may leverage communications hardware 206 to cause transmission of the session token to the user device that corresponds with the received user authentication request. For example, session management circuitry 208 may leverage communications hardware 206 to cause transmission of the generated session token to user device 106A via a network (e.g., communications network 104, shown in FIG. 1). The transmission of the generated session token to a computing device enables the intelligent call routing system 102 to validate the token before granting the computing device access to particular resources, such as user data (e.g., PII, account numbers, or the like). To this end, establishing an authenticated session with a user before receiving an in-application call (e.g., a VoIP call initiated during an authentication session) enhances security because a tampered token would invalidate the generated signature, and thus cause termination of the authenticated session, which would in turn prohibit the transmission of a VoIP request to the apparatus 200. In addition, the use of tokens reduces the computational workload and enhances efficiency of the session authentication operations performed by the apparatus 200 because the use of tokens replaces the need for the apparatus 200 to periodically or continuously query a database with stored session information that would otherwise be required for authentication during an established authenticated session. Moreover, requiring the establishment of an authenticated session before a user may initiate a VoIP call by submitting a VoIP request increases security by ensuring, based on the generated token's integrity, that only legitimate (e.g., authorized) users can submit such requests during the authenticated session.

As shown by operation 310, the apparatus 200 includes means, such as processor 202, memory 204, communications hardware 206, session management circuitry 208, or the like, for generating a user activity log. The user activity log may be a data construct that includes a record of one or more actions and/or one or more interactions that a particular user may perform during an authenticated session. For example, the user activity log may comprise an indication of the pages visited by the user, clicks performed on a particular page, keystrokes performed on a particular page, a duration of time spent on each page, any errors that were encountered by the user, interactions with particular features, such as playing videos, using a search functionality, and/or the like. The user activity log may be associated with a particular user and may be stored in a user profile that is in association with a particular user account. The user activity log may be stored in a local storage device (e.g., memory 204, or the like). As such, the user activity log may be stored in the user profile to which the user activity log corresponds. For example, if user activity log A corresponds to user A, user activity log A may be stored in a user profile associated with user A, which may in turn be stored in memory 204.

In some embodiments, session management circuitry 208 may generate a user activity log concurrently with the establishment of an authenticated session with the user (e.g., the established authenticated session described above in relation to operation 308). Additionally or alternatively, the user activity log may initiate in response to an activity log trigger event. An activity log trigger event may include an activity log circumstantial trigger event, or the like. For example, an activity log circumstantial trigger event may take place based on rules and/or configurations predefined by an entity (e.g., an entity that utilizing intelligent call routing system 102 to provide intelligent call routing) that requires a computing device generate a user activity log in response to the establishment of an authenticated session with the user, the user performing a particular action, or the like. Once the user activity log is generated, the user activity log may be updated (e.g., continuously, periodically, or the like) throughout the duration of the authenticated session with the user. Updating the user activity log is described in further detail below in relation to FIG. 4.

Turning now to FIG. 4, example operations are shown for updating a user activity log.

As shown by operation 402, the apparatus 200 includes means, such as processor 202, memory 204, communications hardware 206, or the like, for receiving a user activity update set. The user activity update set may comprise an indication of the session token that was generated and transmitted to the user device (e.g., user device 106A, or the like), an indication of an action (e.g., an activity or interaction) that was performed by a user during an authenticated session, a timestamp that indicates when the action occurred, contextual data (e.g., the uniform resource locator (URL) of the page where the action occurred), keystroke data, mouse click data, or any other data that indicates occurrence of user interaction and/or an action. For example, the user activity update set may be structured as a hypertext transfer protocol (HTTP) request (e.g., HTTP request, HTTP/2 request or HTTP/3 request), such as a POST request, that comprises a payload with an indication of the session token (e.g., ‘abcde12345’), an indication of the action (e.g., ‘page visit’), a time stamp (e.g., 2024-07-19T15: 08:32 ET), and/or contextual data (e.g., page URL: https://asdfgh.com/customersupport).

In some embodiments, the apparatus 200 may receive a user activity update set from the computing device that is associated with the established authenticated session (e.g., a computing device, such as user device 106A, which received the session token that was generated as described above in relation to operation 308). For example, communications hardware 206 may receive the user activity update set from user device 106A via a network (e.g., communications network 104, shown in FIG. 1). In some embodiments, upon receiving the user activity update set, communications hardware 206 may store the user activity update set in a local storage device (e.g., memory 204, or the like). Additionally or alternatively, communications hardware 206 may immediately transmit the received user activity update set to another component of the apparatus 200 (e.g., session management circuitry 208, or the like), which may enable the session management circuitry 208 to immediately determine the particular activity and/or the particular user that is indicated in the user activity update set, and thus may enable session management circuitry 208 to update the user activity log accordingly (based on the determined activity and/or user).

In some embodiments, a user activity update set may be received by the apparatus 200 (e.g., communications hardware 206) in response to an occurrence of an automatic trigger event that occurs during an established authenticated session. An automatic trigger event may include a circumstantial trigger event, a temporal trigger event, or the like. A circumstantial trigger event may take place based on rules and/or configurations predefined by an entity (e.g., an entity that utilizing intelligent call routing system 102 to provide intelligent call routing) that requires a computing device associated with the user and a corresponding active established authenticated session (e. user device 106A, user device 106N, or the like) to transmit a user activity update set from the computing device to the apparatus 200 (e.g., communications hardware 206). For example, session management circuitry 208 may configure a circumstantial trigger that causes a computing device associated with a user and a corresponding established authenticated session to transmit a user activity update set to communications hardware 206 via a network (e.g., communications network 104, shown in FIG. 1) in response to the user performing an operation on their user device that leaves the current page that the user device was previously displaying to the user.

A temporal trigger event may take place based on rules and/or configurations predefined by an entity (e.g., an entity that utilizing intelligent call routing system 102 to provide intelligent call routing) that requires a computing device associated with a user and a corresponding established authenticated session to transmit a user activity update set to the apparatus 200 (e.g., communications hardware 206) within a particular time period or at a particular point in time. For example, session management circuitry 208 may configure a temporal trigger that causes a periodic (e.g., every 30 seconds, every minute, or the like) transmission of a user activity update set to communications hardware 206 via a network (e.g., communications network 104, shown in FIG. 1).

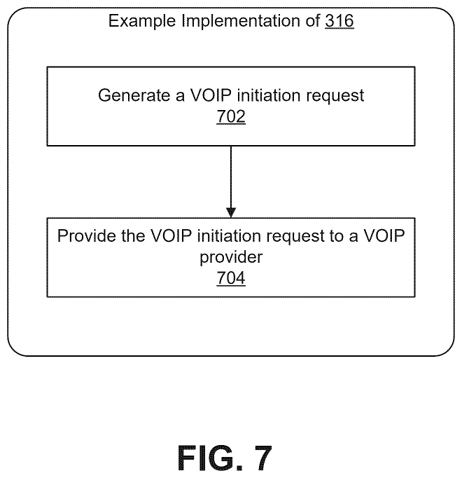

In some embodiments, the received user activity update set may be received by the apparatus 200 (e.g., communications hardware 206) in real-time in response to the occurrence of an automatic trigger event. For example, the reduced latency offered by HTTP/3 requests (e.g., a user activity update set) may allow for communications hardware 206 to receive a user activity update request in real-time, which in turn enables the apparatus 200 (e.g., session management circuitry 208, smart routing engine 210, or the like) to subsequently update the user activity log (as described below in relation to operations 404 and 406) in real-time. To this end, since the apparatus 200 may receive user activity update sets in real-time, the apparatus 200 is able to perform actions, such as generating updates to the user activity log, transmitting VoIP initiation requests (described further below in relation to FIG. 7), or the like, in real-time.

As shown by operation 404, the apparatus 200 includes means, such as processor 202, memory 204, session management circuitry 208, or the like, for determining an activity parameter set based on the user activity update set. An activity parameter set may describe particular parameters associated with an action that was were recorded in the user activity update set. Some example parameters may include but are not limited to actions (e.g., page visits, file uploads, errors encountered, file downloads, form submissions, interactions with particular features presented to the user via a computing device (e.g., user device 106A, or the like), such as playing a video, using a search function, or the like), a time stamp associated with the performed action, the session token associated with the user activity update set, the uniform resource locator (URL) of the page where the action occurred, an indication of a user's intent within a predefined period of time associated with the occurrence of the action, such as keystroke data, clicks, or any other data that indicates user interaction, or the like.

In some embodiments, session management circuitry 208 may utilize any suitable technique to determine a parameter associated with the activity parameter set. For example, session management circuitry 208 may utilize optical character recognition (OCR), natural language processing (NLP), searching algorithms, and/or the like, to determine the activity parameter set. By means of continuing example, session management circuitry 208 may utilize OCR to identify an indicator that corresponds to a particular activity. As a result, session management circuitry 208 may determine, based on the received user activity update set that comprises an indication of an action (e.g., “form submission), that the term “form submission” that is included in the received user activity update set is an indicator of a form submission action, and thus may determine that a particular action indicated in the user activity update set is a form submission action. To this end, session management circuitry 208 may subsequently store (e.g., in a local storage device, such as memory 204) the determined parameters in an activity parameter set.

As shown by operation 406, the apparatus 200 includes means, such as processor 202, memory 204, session management circuitry 208, or the like, for updating the user activity log. The user activity log may be a data construct that includes a record of one or more actions and/or one or more interactions that a particular user may perform during an authenticated session. As such, a particular user activity log may correspond with a particular individual (e.g., a particular user) and a particular session token. In some embodiments, session management circuitry 208 may update the user activity log in response to determining the activity parameter set (as described above in relation to operation 404). For example, session management circuitry 208 may retrieve the activity parameter set from a local storage device, such as memory 204, and subsequently update the user activity log accordingly to include an indication of the determined activity and its corresponding determined parameters. To do so, in some embodiments, upon retrieving the activity parameter set, which may comprise an indication of a session token, session management circuitry 208 may verify the indication of the session token by comparing the indication to a stored indication of the session token. Session management circuitry 208 may determine the authenticity (e.g., legitimacy) of the user activity update set and the determined activity parameter set based on whether the indication of the session token matches the stored indication of the session token corresponding to a particular established authenticated session with a user and whether the session token is active or expired.

Upon determining an authentic and active session token (e.g., based on the comparison), session management circuitry 208 may update the user activity log based on the activity parameter set. As a result, session management circuitry 208 may store the determined activity parameter set in an already existing user activity log associated with the active generated session token. Alternatively, if a user activity log is not already generated for a particular active authentic session, session management circuitry 208 may generate a user activity log associated with the particular user and particular session token indicated in the received user activity update set and subsequently store the generated user activity log within a local storage device (e.g., memory 204, or the like) or external storage device (e.g., a data repository that may be embodied by one or more DAS devices (such as hard drives, solid-state drives, optical disc drives, or the like) or may alternatively comprise one or more NAS devices independently connected to a communications network (e.g., communications network 104).

Returning to FIG. 3, as shown by operation 312, the apparatus 200 includes means, such as processor 202, memory 204, communications hardware 206, or the like, for receiving a VoIP request. The VoIP request may be an electronic request that comprises at least an indication of the user authentication result. For example, the VoIP request may comprise at least an indication of the session token that was generated in operation 308. In some embodiments, the VoIP request may be received in response to user interaction with a user device (e.g., user device 106A) during an established authenticated session. For example, user device 106A may display an icon with text that instructs a user to interact with (e.g., click, hover a cursor, or the like) the icon to initiate an intelligent VoIP call with a customer service agent. Continuing the above example, upon user interaction with the icon, the particular user device (e.g., user device 106A) that displayed the icon and is associated with the established authenticated session may transmit the VoIP request to the apparatus 200 (e.g., communications hardware 206).

To this end, the apparatus 200 (e.g., communications hardware 206) may receive a VoIP request from the computing device associated with the established authenticated session (e.g., user device 106A) via a network (e.g., communications network 104, shown in FIG. 1). In some embodiments, communications hardware 206 may subsequently store the VoIP request in a local storage device, such as memory 204, or the like. Additionally or alternatively, communications hardware 206 may transmit the VoIP request to smart routing engine 210, which may allow for smart routing engine 210 to immediately begin analyzing the VoIP request to determine an intelligent smart routing destination (e.g., a routing destination for the VoIP request and/or the user activity log) to route the requested VoIP call.

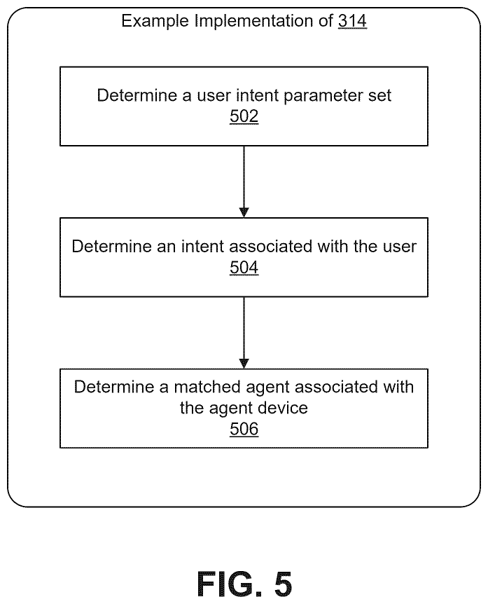

As shown by operation 314, the apparatus 200 includes means, such as processor 202, memory 204, smart routing engine 210, or the like, for determining an agent device to connect with the user. In some embodiments, an agent device may be any computing device known in the art that is associated with an employee that specializes in resolving customer queries (e.g., a customer service agent and hereinafter referred to as an agent). In some embodiments, an agent may be associated with particular types of customer queries. For example, a particular agent may specialize in general conflict resolution, technical support, billing support, support for any other particular department, or the like. In addition, a particular agent may specialize in resolving customer queries when a particular customer (e.g., a user) is upset or otherwise disgruntled. As such, smart routing engine 210 may determine an agent device to connect with the user, such that the particular agent that is associated with the determined agent device is best suited to resolve the particular customer query associated with the received VoIP request. Example operations that are performed by the apparatus 200 (e.g., smart routing engine 210) for determining an agent device to connect with the user are described in further detail below in relation to FIG. 5.

Turning now to FIG. 5, example operations are shown for determining a matched agent.

As shown by operation 502, the apparatus 200 includes means, such as processor 202, memory 204, smart routing engine 210, or the like, for determining a user intent parameter set. A user intent parameter set may comprise one or more parameters that describe particular features associated with a particular user's experience during an established authenticated session. Each of the one or more parameters may ultimately be utilized to determine insights about a particular user's experience during an established authenticated session. For example, the one or more parameters may be utilized to determine a user's intent, which is described further below in relation to operation 504.

In some embodiments, smart routing engine 210 may retrieve the user activity log and a user intent parameter determination rule set from a local storage device, such as memory 204. The user intent parameter determination rule set may describe particular rules that smart routing engine 210 may utilize to determine particular parameters included in the user intent parameter set. For example, the user intent parameter determination rule set may describe that a particular parameter, such as navigation complexity, may be determined based on the number of unique pages visited by the user during an established authenticated session. In this regard, smart routing engine 210 may search the retrieved user activity log to determine the number of unique pages visited during the authenticated session. Upon determining the number of unique pages visited, smart routing engine 210 may store the determined number of unique pages in a user intent parameter set, which may in turn be stored in a local storage device (e.g., memory 204, or the like). This user intent parameter determination process may be performed (e.g., iteratively or in parallel) for each parameter (e.g., navigation complexity, error frequency, user engagement time, mouse click intensity, typing speed, or the like) described by the user intent parameter determination rule set.

As shown by operation 504, the apparatus 200 includes means, such as processor 202, memory 204, smart routing engine 210, or the like, for determining an intent associated with the user. An intent may describe a user's particular goal and/or emotional state during an authenticated session. For example, assume a user is navigating a technical support page on their respective computing device (e.g., user device 106A, or the like) while repeatedly clicking a particular location on a display that is illustrated to the user via their respective computing device. As a result, this particular user's intent may describe the user's frustration while trying to solve a particular issue that may require technical support. In some embodiments, smart routing engine 210 may determine a user's intent based on the user intent parameter set that was determined in operation 502.

In some embodiments, smart routing engine 210 may leverage an intent determination model to ultimately determine a particular user's intent during an established authenticated session. The intent determination model may use any suitable method to combine the one or more user intent parameters included in the user intent parameter set to ultimately determine an intent associated with the user. For example, the intent determination model may utilize intent determination rules, which may be stored in a local storage device (e.g., memory 204, or the like), to determine an intent associated with the user. In some embodiments, the intent determination rules may describe particular scores that may be associated with each particular parameter included in a user intent parameter set. The particular scores may be predefined by the entity (e.g., a business, individual, or the like) that is offering the intelligent in app call routing service provided by intelligent call routing system 102. The intent determination rules may further describe a corresponding intent associated with particular values that are associated with each particular user intent parameters. For example, the user intent determination rules may describe that a mouse click intensity of more than 10 mouse clicks on a particular page with a predefined time period may automatically cause the intent determination model to determine a “frustrated” intent for the user. In another example, the user intent determination rules may be utilized by the intent determination model to determine a particular intent based on the user intent parameter dataset corresponding values. For example, the user intent determination rules may describe a decision tree that indicates a particular intent based on the values associated with corresponding parameters included in the user intent parameter set.

In another example, the intent determination model may be a machine learning model. In this regard, the intent determination model may be trained using a large training dataset comprising user intent parameter sets that are labeled with the particular intent to which each user intent parameter set corresponds. As a result, the intent determination model may learn weights for each particular input user intent parameter, and thus may utilize these learned weights to account for each parameter included in the user intent parameter set accordingly while determining an intent.

As shown by operation 506, the apparatus 200 includes means, such as processor 202, memory 204, communications hardware 206, smart routing engine 210, or the like, for determining a matched agent. A matched agent may be a particular agent that is well-suited to attempt to resolve a particular customer query based on the agent's corresponding attributes. In some embodiments, each agent may be associated with a plurality of agent attributes that describe each agent's particular capabilities. In this regard, an agent attribute set, which may be stored in a local storage device, such as memory 204, may include a plurality of attributes and a corresponding value associated with each attribute for each agent. For example, the agent attribute set may indicate particular skills associated with each agent (e.g., troubleshooting technical issues, providing product information, billing support, account management, or the like), experience level (e.g., beginner, intermediate, advanced, expert), availability (e.g., available to assist, not available to assist, or the like), performance metrics (e.g., average problem resolution time, customer satisfaction scores, or the like), or the like.

In some embodiments, the attributes in the agent attribute list may continuously change. For example, an agent's availability may change throughout the course of a day. As a result, the apparatus 200 (e.g., smart routing engine 210) may continuously update the agent attribute set in response to receiving agent update data. Agent update data may refer to any data that comprises an update to an attribute in the agent attribute list. For example, communications hardware 206 may obtain access (e.g., via an API) to a digital platform associated with the work environment that the agents utilize. In this regard, communications hardware 206 may subscribe to events or hooks provided by an API associated with the digital platform to ultimately intercept and receive changes to attributes associated with each agent in real-time. For example, assume communications hardware 206 is subscribed to a particular status changing event provided by an API that is associated with the digital platform utilized by agents. As a result, upon the occurrence of an agent's status changing (e.g., manually or automatically changing), the digital platform may trigger the corresponding event and thus cause the apparatus 200 (e.g., communications hardware 206) to receive agent update data that indicates the changed status and the particular agent that changed their status. Since the apparatus 200 is able to receive real-time updates to agent attribute data, this allows for the intelligent call routing service offered by intelligent call routing system 102 to respond to changing data in-real time, and thus provide an improved call routing system that routs customer calls based on insights that account for the dynamic nature of continuously changing agent attribute data.

In some embodiments, smart routing engine 210 may leverage a matching machine learning model to determine a matched agent. The matching machine learning model may generate a match score for each available agent that is indicated in the agent attribute set. The matching machine learning model may ultimately determine a matched agent and agent device associated with the matched agent based on the matched agent with the highest match score. The match score may be a numerical score (e.g., a score between 0 and 1), a categorical result (high match, medium match, low match, or the like), and/or the like. The match score may be generated based on a plurality of partial match scores that are generated by the matching machine learning model for each agent attribute. For example, the matching machine learning model may determine a partial match score between the determined intent (as described above in relation to operation 504) and the skills associated with the agent, the experience level, availability, resolution time, or the like.

In some embodiments, the matching machine learning model may combine the partial match scores to generate the match score for a particular agent based on weights that were learned during training. For example, the matching machine learning model may be trained using a large training dataset that comprises matches that were performed based on a particular user parameter set and agent attribute set. In addition, the large training dataset may comprise a match quality indicator that indicates the quality of the determined match. As a result, the machine learning model may learn weights for each partial match score generated by the matching machine learning model, and thus may utilize these learned weights to combine each partial match score that is generated to ultimately calculate the match score.

In some embodiments, smart routing engine 210 may determine, based on a unique device ID (e.g., MAC address, serial number, or the like), a corresponding agent device that is associated with the matched agent (e.g., agent device 108A, agent device 108N, or the like) to connect with the user. For example, the agent attribute dataset may include a unique device ID associated with each agent, and thus may include the unique device ID associated with the computing device that corresponds with agent associated with the highest match score.

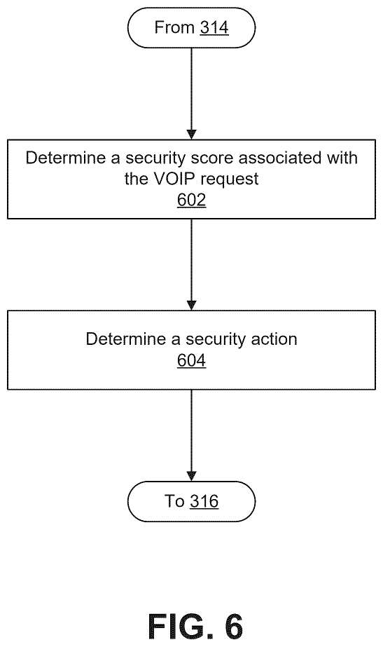

Turning now to FIG. 6, example operations are shown for determining a security action.

As shown by operation 602, the apparatus 200 includes means, such as processor 202, memory 204, smart routing engine 210, or the like, for determining a security score associated with the VoIP request. In some embodiments, the security score may be a numerical score that indicates the degree of confidentiality required to safely resolve a user's query. For example, the security score may be a numerical score between the values of 0 and 1, where a value closer to 0 indicates that the content discussed during the VoIP call is not likely to include and/or be associated with confidential information (e.g., personal identifiable information (PII), or the like) and a value closer to 1 indicates that the content discussed during the VoIP call is likely to include and/or be associated with confidential information. In some embodiments, the security score may not be a numerical score, but rather a categorical result, such as tier 1/tier 2/tier 3, green, yellow, red, or some other type of categorical result.

In some embodiments, metadata associated with the VoIP request may be utilized by smart routing engine 210 to generate a security score. In this regard, smart routing engine 210 may determine a metadata parameter set, which may be stored in a local storage device (e.g., memory 204, or the like), that describes metadata (e.g., a time stamp associated with the reception of the request, device information associated with the request, and/or the like) that is associated with the VoIP request. In some embodiments, smart routing engine 210 may determine one or more metadata parameters by, for example, (i) logging the exact time and date when communications hardware 206 received the VoIP request, (ii) capturing the internet protocol (IP) address associated with the computing device that transmitted the VoIP request (e.g., user device 106A, or the like), and/or the like.

To this end, smart routing engine 210 may determine the security score based on the determined user intent and/or metadata parameter set. In some embodiments, smart routing engine 210 may leverage a security scoring model to determine a security score associated with a particular user's intent. The security scoring model may be a rules-based model, machine learning model, or the like. For example, a rules-based security scoring model may rely upon a set of security scoring rules that are determined by the entity offering the intelligent in-application calling service provided by intelligent call routing system 102 and are stored in a local storage device (e.g., memory 204, or the like). As such, the set of security scoring rules may describe a partial security score to assign particular input parameters, such as a particular user intent, particular metadata parameters included in the metadata parameter set (e.g., location of the computing device that transmitted the VoIP request, the date/time the VoIP request was received, IP address of the computing device that transmitted the VoIP request, network type (e.g., mobile data or Wi-Fi) or the like), or the like. Moreover, the set of security scoring rules may also describe weights for each input for the security scoring model, such that the security score is weighted accordingly and thus accounts for the various importances of the plurality of different inputs.

Alternatively, the security scoring model may be a machine learning model (e.g., a logistic regression model). For example, the machine learning security scoring model may be iteratively trained on a corpus of labeled training data. The corpus of labeled training data may comprise data that corresponds to VoIP calls that discussed confidential information and data the corresponds to VoIP calls that did not discuss confidential information, which may be labeled accordingly. During training, the machine learning security scoring model may learn a variety of weights for a plurality of input features. In particular, the machine learning security scoring model may learn corresponding weights for each parameter that may be included in the metadata parameter set, such as time-based features associated with when the VoIP request was received (e.g., hour of the day, day of the week, month of the year, or the like), network features (e.g., known/unknown IP address, network type such as Wi-Fi or mobile data, or the like), device features (e.g., a known user device, or the like), location features (e.g., distance from a known location, or the like), intent features (e.g., the type of intent, emotional state associated with the intent, particular user query, or the like), or the like. To this end, smart routing engine 210 may retrieve the metadata parameter set and determined intent from a local storage device (e.g., memory 204, or the like) and subsequently provide the metadata parameter set and/or determined intent to the security scoring model to output a security score.

As shown by operation 604, the apparatus 200 includes means, such as processor 202, memory 204, smart routing engine 210, or the like, for determining a security action. The security action may refer to a real-world action that may be performed to provide appropriate security (e.g., encrypting the VoIP call) to a corresponding VoIP call. In some embodiments, smart routing engine 210 may determine a particular security action to perform based on a corresponding security score. In this regard, a local storage device (e.g., memory 204, or the like) may comprise a security action database that includes one or more security actions that are associated with a particular security score. For example, the security action database may store the security actions and the security score to which the security action corresponds in the form of key-value pairs, where the key portion specifies the security score, and the value portion specifies the corresponding security action. For example, assume the security score that was determined in operation 602 was 0.93. As a result, smart routing engine 210 may retrieve the security action database and use the determined security score (e.g., 0.93) to determine a corresponding security action. In another example, assume the security score that was determined in operation 602 is 0.13. In this regard, the corresponding security action defined by the security action database may identify that no security action is required to ensure the security of the VoIP call.

In some embodiments, an indication of the determined security action may be included in a VoIP initiation request to ensure the performance of any necessary security actions while establishing a VoIP call between the user device (e.g., user device 106A, or the like) and the agent device associated with the determined matched agent (e.g., agent device 108A, or the like).

Returning to FIG. 3, as shown by operation 316, the apparatus 200 includes means, such as processor 202, memory 204, communications hardware 206, smart routing engine 210, or the like, for establishing a VoIP call between the user device and the agent device. In some embodiments, operation 316 may be performed in accordance with the operations described by FIG. 7. Turning now to FIG. 7, example operations are shown for providing the VoIP initiation request to a VoIP provider.

As shown by operation 702, the apparatus 200 includes means, such as processor 202, memory 204, smart routing engine 210, or the like, for generating a VoIP initiation request. In some embodiments, the VoIP initiation request may be an electronic request that is formatted as a session initiation protocol (SIP) request, such that a corresponding computing device associated with a VoIP provider (e.g., VoIP provider system 110A through 110N) may receive the VoIP initiation request and immediately establish the VoIP call based on the contents included in the request. The VoIP initiation request may comprise various headers and corresponding bodies that describe various parameters that a VoIP provider may require to establish a VoIP call between an agent device and a user device. For example, the VoIP initiation request may identify the caller device (e.g., user device 106A) and the callee device (e.g., agent device 108A) via a unique identifier, such as a corresponding unique device ID, an indication that the request was transmitted via the intelligent call routing system 102, a max-forwards limit that limits the number of hops the VoIP initiation request may take, an indication of any required security actions (e.g., encrypting the VoIP call), or the like. To this end, smart routing engine 210 may generate the VoIP initiation request to be formatted as a SIP request and to include a variety of headers and corresponding bodies that describe various parameters the VoIP provider may use to ultimately establish the VoIP call. Upon generation of the VoIP initiation request, smart routing engine 210 may store the VoIP initiation request in a local storage device (e.g., memory 204, or the like).

As shown by operation 704, the apparatus 200 includes means, such as processor 202, memory 204, communications hardware 206, or the like, for providing the VoIP initiation request to a VoIP provider. A VoIP provider may be any service provider (e.g., an entity) that offers Voice over Internet protocol services. In some embodiments, communications hardware 206 may transmit the VoIP initiation request to a computing device associated with a VoIP provider (e.g., VoIP provider system 110A, VoIP provider system 110N, or the like), such that the VoIP provider may establish the VoIP call between the user device (e.g., user device 106A, or the like) and the matched agent device (e.g., agent device 108A, or the like). For example, communications hardware 206 may transmit the VoIP initiation request to VoIP provider system 110A via a network (e.g., communications network 104, shown in FIG. 1.

To this end, since the VoIP provider may receive the VoIP initiation request that includes any necessary parameters to ensure a secure VoIP call between a user and an agent, the VoIP provider may subsequently establish a VoIP call between the computing devices that are indicated in the VoIP initiation request (e.g., user device 106A and agent device 108A) by completing a SIP handshake. For example, the VoIP provider may provide an electronic call set-up request to the corresponding agent device (e.g., agent device 108A), which may cause the agent device to ring. In response to the agent responding successfully to the call set-up request (e.g., answering the phone), the VoIP provider may then provide a corresponding electronic call set-up request to the user device (e.g., user device 106A), which may cause the user device to ring. Upon answering the ringing user device, the SIP handshake may be completed, and thus the VoIP call may be established between the user and an agent by connecting the user device to the agent device corresponding with the determined matched agent.

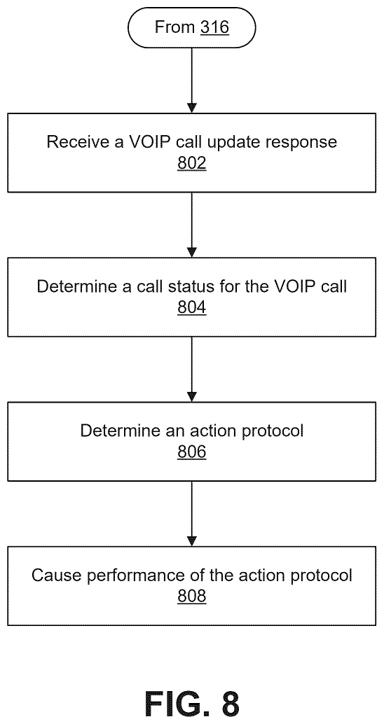

In some embodiments, the apparatus 200 may receive updates pertaining to the established VoIP call and may perform actions in response to the received updates. Turning now to FIG. 8, example operations are shown for causing performance of an action protocol based on a call update response.

As shown by operation 802, the apparatus 200 includes means, such as processor 202, memory 204, communications hardware 206, or the like, for receiving a call update response. The call update response may be a data construct that comprises data that describes a particular state (e.g., a call-status) associated with the established VoIP call. For example, the call update response may comprise an indication that the VoIP call was successfully or not successfully established, that the VoIP call was terminated, or the like. In this regard, the apparatus 200 (e.g., smart routing engine 210, or the like) may utilize the received call update response to perform actions in real-time based on the call update response, which enables the apparatus 200 to perform actions that may further increase security and/or increase participant trust in real-time, and thus the apparatus 200 may cause performances of actions that account for a call status (e.g., connected, connecting, not connected, or the like) that may change at any time during an established VoIP call.

In some embodiments, the call update response may be received by the apparatus 200 (e.g., communications hardware 206). For example, communications hardware 206 may receive the call update response from a computing device associated with a VoIP provider (e.g., VoIP provider system 110A, VoIP provider system 110N, or the like) via a network (e.g., communications network 104, shown in FIG. 1). In response to receiving the call update response, communications hardware 206 may store the call update response in a local storage device (e.g., memory 204, or the like). Additionally or alternatively, communications hardware 206 may immediately transmit the received call update response to smart routing engine 210, so that smart routing engine 210 may immediately determine a call status and corresponding action protocol based on the received call update response.

Moreover, the call update response may be received in response to the occurrence of a call update response automatic trigger event. A call update response automatic trigger event may include a call update circumstantial trigger event, a call update temporal trigger event, or the like. A call update circumstantial trigger event may take place based on rules and/or configurations predefined by an entity (e.g., an entity that utilizing intelligent call routing system 102 to provide intelligent call routing) that requires a VoIP provider system (e.g., VoIP provider system 110A, VoIP provider system 110N, or the like) to transmit a call update response to the apparatus 200 (e.g., communications hardware 206). For example, smart routing engine 210 may configure a call update circumstantial trigger that causes a computing device associated with a VoIP provider that is establishing the VoIP call to transmit a call update response via a network (e.g., communications network 104, shown in FIG. 1) to communications hardware 206 if the call status (e.g., connected, connecting, or not connected) associated with the established VoIP call changes.

A call update temporal trigger event may take place based on rules and/or configurations predefined by an entity (e.g., an entity that utilizing intelligent call routing system 102 to provide intelligent call routing) that requires a computing device associated with a VoIP provider (e.g., VoIP provider system 110A, VoIP provider system 110N, or the like) to transmit a call update response to the apparatus 200 (e.g., communications hardware 206) within a particular time period or at a particular point in time. For example, smart routing engine 210 may configure a temporal trigger that causes a periodic (e.g., every 30 seconds, every minute, or the like) transmission of a call update response to communications hardware 206 via a network (e.g., communications network 104, shown in FIG. 1).

As shown by operation 804, the apparatus 200 includes means, such as processor 202, memory 204, communications hardware 206, smart routing engine 210, or the like, for determining a call status for the VoIP call. The call status may describe a particular state associated with the established VoIP call. For example, the call status may describe whether the VoIP call has been successfully established and if the VoIP the call has not been successfully established, the call status may indicate the computing device(s) that has not been able to successfully connect to the VoIP call. In some embodiments, an indication of a call status of a VoIP call may be included in the call update response that was received as described above in relation to operation 802. In this regard, smart routing engine 210 may use any suitable technique to determine the call status from the received call update response, such as optical character recognition (OCR), natural language processing (NLP), searching algorithms, and/or the like. For example, smart routing engine 210 may utilize OCR to identify an indicator that corresponds to a particular call status. In response to determining the call status, smart routing engine 210 may subsequently store the determined call status in a local storage device (e.g., memory 204, or the like).

As shown by operation 806, the apparatus 200 includes means, such as processor 202, memory 204, smart routing engine 210, or the like, for determining an action protocol. An action protocol may refer to a real-world action that may be performed in response to the determination of a particular call status. For example, upon determining that the call is connected, an action protocol may describe a series of operations for the apparatus 200 to perform to ensure the security of the VoIP call and ensure that all participants (e.g., the caller and the callee) trust its security. As such, smart routing engine 210 may determine an action protocol based on the determined call status. In this regard, a local storage device (e.g., memory 204, or the like) may comprise an action protocol database that includes one or more action protocols that correspond with a particular call status. For example, the action protocol database may store an action protocol and corresponding call status in the form of key-value pairs, where the key portion specifies the call status, and the value portion specifies the corresponding action protocol(s). For instance, assume the determined call status is a “call connected” call status, which indicates that the VoIP call is currently active, and the participants are connected to the VoIP call. In this regard, smart routing engine 210 may retrieve the action protocol database from memory 204 and subsequently search the retrieved database for a value corresponding to the key (e.g., call connected).

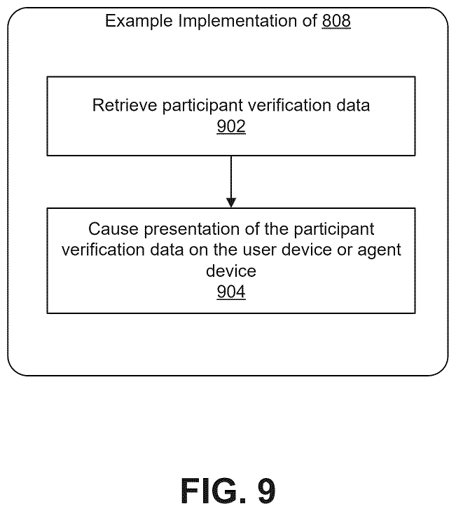

As shown by operation 808, the apparatus 200 includes means, such as processor 202, memory 204, communications hardware 206, smart routing engine 210, or the like, for causing performance of the action protocol. In some embodiments, operation 808 may be performed in accordance with the operations described by FIG. 9. Turning now to FIG. 9, example operations are shown for causing presentation of participant verification data on the user device and/or agent device.

As shown by operation 902, the apparatus 200 includes means, such as processor 202, memory 204, smart routing engine 210, or the like, for retrieving participant verification data. The participant verification data may be data that is stored in a local storage device (e.g., memory 204, or the like that may be utilized by a participant of the established VoIP call to verify the other party (e.g., the caller or callee). For example, participant verification data may refer to a participant's full name, particular model of the computing device that is used, a photo of the participant, or the like. To this end, participant verification data may be stored within a user profile associated with each user and/or agent associated with the in-application call routing service provided by the intelligent call routing system 102. As such, smart routing engine 210 may retrieve participant verification data for each participant from a local storage device.

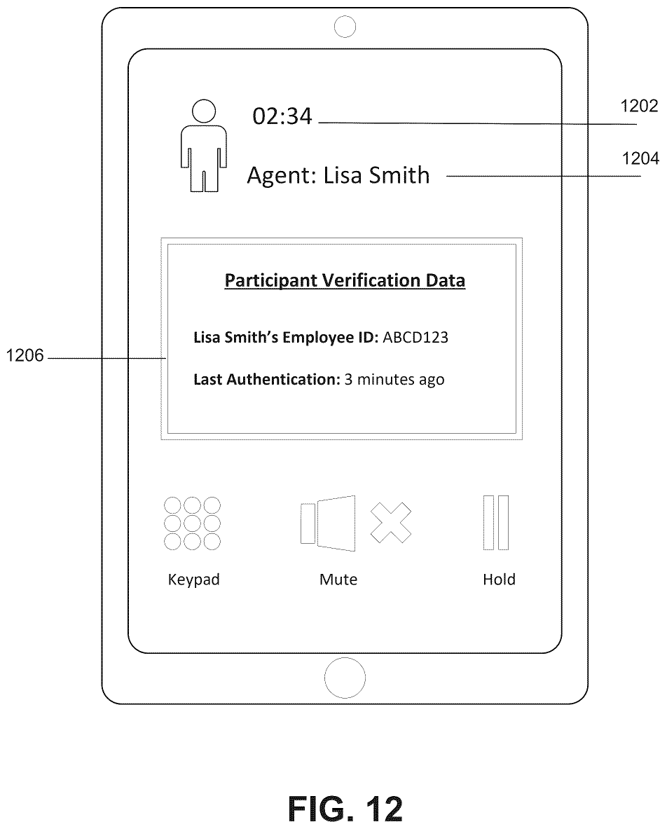

As shown by operation 904, the apparatus 200 includes means, such as processor 202, memory 204, communications hardware 206, or the like, for causing presentation of an indication of the participant verification data on the user device (e.g., user device 106A, or the like) or the agent device (e.g., agent device 108A, or the like). In some embodiments, communications hardware 206 may transmit instructions to each computing device to display a corresponding participant verification data on a corresponding user device or agent device. For example, communications hardware 206 may transmit instructions via a network (e.g., communications network 104, shown in FIG. 1) for user device 106A to display participant verification data associated with matched agent. Additionally or alternatively, communications hardware 206 may transmit instructions via a network (e.g., communications network 104, shown in FIG. 1) for agent device 108A to display participant verification data associated with the user. An example illustration of a display of a user device that illustrates participant verification data associated with the agent is illustrated and described further below in relation to FIG. 12.

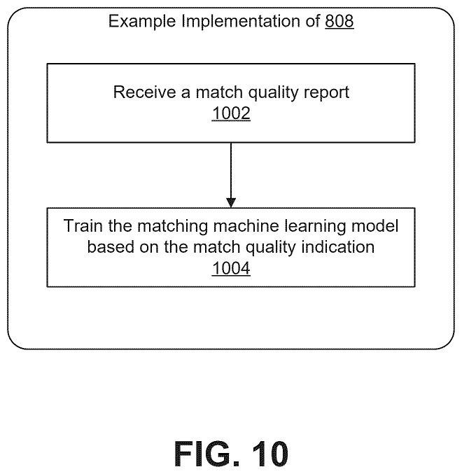

Additionally, operation 808 may be performed in accordance with the operations described by FIG. 10. Turning now to FIG. 10, example operations are shown for training the matching machine learning model based on the match quality indication.

As shown by operation 1002, the apparatus 200 includes means, such as processor 202, memory 204, communications hardware 206, or the like, for receiving a match quality report. The match quality report may be an electronic report that comprises a match quality indication that indicates customer and/or agent satisfaction based on the matching between the user and the agent. For example, the match quality indication may be a numerical score (e.g., a score between 0 and 1), a categorical result (e.g., high quality, medium quality, low quality), and/or the like. In some embodiments, communications hardware 206 may receive the match quality report from a user via a user device (e.g., user device 106A, or the like) and/or from an agent via an agent device (e.g., agent device 108A, or the like). For example, communications hardware 206 may receive the match quality report from user device 106A via a communications network (e.g., communications network 104, shown in FIG. 1). Upon receiving the match quality report, communications hardware 206 may store the match quality report in a local storage device (e.g., memory 204). Additionally or alternatively, communications hardware 206 may immediately transmit the match quality report to smart routing engine 210 to enable smart routing engine 210 to quickly determine the match quality indicator and subsequently train the matching machine learning model using the determined match quality indicator (as described below in relation to operation 1004).

As shown by operation 1004, the apparatus 200 includes means, such as processor 202, memory 204, smart routing engine 210, or the like, for training the matching machine learning model based on the match quality indication. The matching machine learning model may generate a match score for each available agent that is indicated in the agent attribute set.

The matching machine learning model may ultimately determine a matched agent and agent device associated with the matched agent based on the matched agent with the highest match score. In some embodiments, smart routing engine 210 may cause training of the matching machine learning model based on the match quality indication, which may allow for the matching machine learning model to continuously improve its match making performance.

To do so, smart routing engine 210 may use any suitable technique, such as optical character recognition (OCR), natural language processing (NLP), searching algorithms, and/or the like, to identify the match quality indicator included in the received match quality report. In some embodiments, if multiple match quality reports are received for the same VoIP call (e.g., a match quality report from the agent and the user), smart routing engine 210 may use any suitable technique to determine a final match quality indicator, such as averaging the received match quality indicators, or the like. If only a singular match quality indicator is received for a particular VoIP call, the singular received match quality indicator may be used to train the matching machine learning model. To this end, smart routing engine 210 may provide the matching machine learning model the match quality indicator or the final match quality indicator, if needed, to cause training of the matching machine learning model where the matching machine learning model may update its corresponding weights accordingly based on the newly received training data (e.g., the match quality indicator).

FIGS. 3-10 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

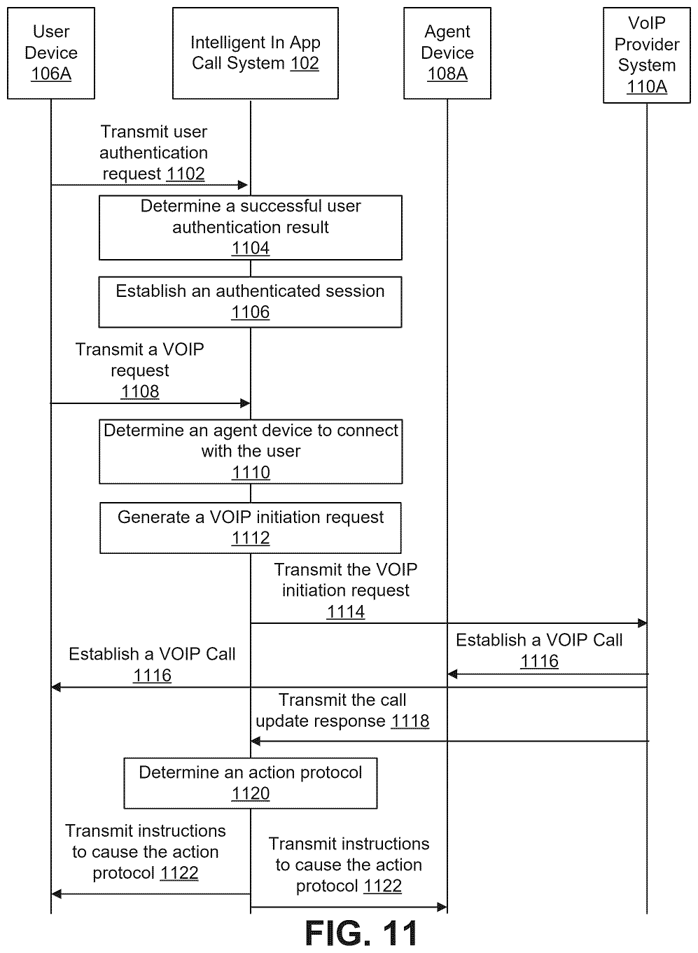

FIG. 11 shows a swim lane diagram illustrating example operations (e.g., as described above in connection with FIGS. 3-10) performed by components of the environment depicted in FIG. 1 to produce various benefits of the implementations described herein. The operations shown in the swim lane diagram performed by user device 106A are shown along the line extending from the box labeled “User Device 106A,” operations performed by intelligent in app call system 102 are shown along the line extending from the box labeled “Intelligent In App Call System 102,” operations performed by agent device 108A are shown along the line extending from the box labeled “Agent Device 108A,” and operations performed by VoIP provider system 110A are shown along the line extending from the box labeled “VoIP provider system 110A.” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIG. 11.

At operation 1102, user device 106A may transmit a user authentication request to intelligent in app call system 102. At operation 1104, intelligent in app call system 102 may determine a successful user authentication result. At operation 1106, intelligent in app call system 102 may establish an authenticated session. At operation 1108, user device 106A may transmit a VoIP request to intelligent in app call system 102. At operation 1110, intelligent in app call system 102 may determine an agent device to connect with the user. At operation 1112, intelligent in app call system 102 may generate a VoIP initiation request. At operation 1114, intelligent in app call system 102 may transmit the VoIP initiation request to VoIP provider system 110A. At operation 1116, VoIP provider system 110A may establish a VoIP call with user device 106A and agent device 108A. At operation 1118, VoIP provider system 110A may transmit a call update response to intelligent in app call system 102. At operation 1120, intelligent in app call system 102 may determine an action protocol. At operation 1122, intelligent in app call system 102 may transmit instructions for user device 106A and agent device 108A to cause performance of the action protocol.

In some embodiments, some of the operations described above in connection with FIGS. 3-10 may be modified or further amplified. Furthermore, in some embodiments, additional optional operations may be included. Modifications, amplifications, or additions to the operations above may be performed in any order and in any combination.

Turning to FIG. 12, a graphical user interface (GUI) is provided that illustrates an example presentation of how performance of an action protocol may cause a user device (e.g., user device 106A) to display participant verification data associated with the other party included on a VoIP call. A user may interact with the intelligent in app call system 102 102 using a user device (e.g., any of user device 106A through user device 106N, as shown in FIG. 1), which may communicate with the intelligent in app call system 102 via communications network 104. In such an embodiment, the GUI shown in FIG. 12 may be displayed to the user by the user device 106A.

Timer 1202 may be automatically displayed on a computing device associated with the user (e.g., user device 106A) while the established VoIP call occurs. Timer 1202 may increase in-real time to display the current length of the established VoIP call. Agent name 1204 may be automatically displayed on the user device once the VoIP call is established. Agent name 1204 may be updated if the VoIP call is routed to a different agent. Participant verification data 1206 may be displayed in response to the establishment of the VoIP call. As a result, participant verification data 1206 may be automatically displayed once the user device (e.g., user device 106A) connects to the corresponding agent device (e.g., agent device 108A).

Alternatively, participant verification data 1206 may be displayed in response to the user interaction (e.g., clicking or hovering a curser over) with agent name 1204. Moreover, the employee ID and last authentication indication may be displayed in response to user interaction with the header “Participant Verification Data.”

### Conclusion

As described above, example embodiments provide methods and apparatuses that enable improved call routing. Example embodiments thus provide tools that overcome the problems faced by conventional methods (e.g., a call centers) to efficiently route a customer call. By using a continuously updated user activity log, example embodiments avoid the need to manually navigate through countless IVR menus to efficiently route a customer call. Thus, example embodiments save time and resources, while also eliminating the possibility of human error (e.g., selecting an incorrect IVR option) that has been unavoidable in the past. Moreover, embodiments described herein improve the security of customer calls by providing the call participants with verification information during an established VoIP call and determining if any necessary security actions (e.g., encryption) are necessary based on a predicted intent of the VoIP call. Finally, by automating functionality that has historically required human analysis, the speed and consistency of the evaluations performed by example embodiments unlocks many potential new functions that have historically not been available, such as the ability to conduct near-real-time dispute resolution.

As these examples all illustrate, example embodiments contemplated herein provide technical solutions that solve real-world problems faced during a call routing process. And while efficiently and securely resolving customer queries has been an issue for decades, the recently exploding amount of data made available by recently emerging technology today has made this problem significantly more acute, as the demand for quick solutions to customer queries has grown significantly even while the complexity of the queries has itself increased. At the same time, the recently arising ubiquity of VoIP calls has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for intelligent in-application calling, the method comprising:
receiving, by communications hardware and from a user device, a user authentication request comprising authentication data associated with a user;
determining, by session management circuitry and based on the authentication data, a user authentication result;
in response to determining a successful user authentication result, establishing, by the session management circuitry, an authenticated session with the user;
generating, by the session management circuitry and during the authenticated session, a user activity log, wherein the user activity log is updated to include an indication of an activity during the authenticated session;
receiving, by the communications hardware and during the authenticated session, a voice over internet protocol (VoIP) request, wherein the VoIP request comprises at least an indication of the user authentication result;
determining, by a smart routing engine and based on the VoIP request and the user activity log, an agent device to connect with the user; and
establishing, by the communications hardware, a VoIP call between the user device and the agent device.

2. The method of claim 1, further comprising:
determining, by the smart routing engine and using an intent determination model, a user intent parameter set based on the user activity log;
determining, by the smart routing engine and based on the user intent parameter set, an intent associated with the user; and
determining, by the smart routing engine and based on the user intent parameter set, a matched agent associated with the agent device.

3. The method of claim 2, wherein a matching machine learning model determines the matched agent.

4. The method of claim 3, further comprising:
receiving, by the communications hardware and from the agent device or the user device, a match quality report, wherein the match quality report comprises a match quality indication; and
training, by the smart routing engine, the matching machine learning model based on the match quality indication.

5. The method of claim 2, further comprising:
determining, by the smart routing engine and based on the intent, a security score associated with the VoIP request; and
determining, by the smart routing engine and based on the security score, a security action, wherein a VoIP initiation request is generated based on the security action.

6. The method of claim 1, further comprising:
generating, by the smart routing engine and based on the agent device, a VoIP initiation request; and
providing, by the communications hardware, the VoIP initiation request to a VoIP provider.

7. The method of claim 6, further comprising:
receiving, by the communications hardware and from the VoIP provider, a call update response during the VoIP call;
determining, by the smart routing engine and based on the call update response, a call status for the VoIP call;
determining, by the smart routing engine and based on the call update response, an action protocol; and
causing, by the smart routing engine, performance of the action protocol.

8. The method of claim 7, wherein causing the performance of the action protocol comprises:
retrieving, by the smart routing engine, participant verification data, wherein the participant verification data is associated with the user; and
causing, by the communications hardware and based on the participant verification data, presentation of an indication of the participant verification data on the agent device.

9. The method of claim 7, wherein causing the performance of the action protocol comprises:
retrieving, by the smart routing engine, participant verification data, wherein the participant verification data is associated with a matched agent; and
causing, by the communications hardware and based on the participant verification data, presentation of an indication of the participant verification data on the user device.

10. The method of claim 1, further comprising:
receiving, by the communications hardware and from the user device, a user activity update set during the authenticated session;
determining, by the session management circuitry and based on the user activity update set, an activity parameter set; and
updating, by the session management circuitry and based on the activity parameter set, the user activity log.

11. An apparatus for intelligent in-application calling, the apparatus comprising:
communications hardware configured to receive, from a user device, a user authentication request comprising authentication data associated with a user;
session management circuitry configured to:
determine, based on the authentication data, a user authentication result,
in response to determining a successful user authentication result, establish, an authenticated session with the user, and
generate, during the authenticated session, a user activity log, wherein the user activity log is updated to include an indication of an activity during the authenticated session;
wherein the communications hardware further configured to receive, during the authenticated session, a voice over internet protocol (VoIP) request, wherein the VoIP request comprises at least an indication of the user authentication result; and
smart routing engine configured to determine, based on the VoIP request and the user activity log, an agent device to connect with the user;
wherein the communications hardware further configured to establish a VoIP call between the user device and the agent device.

12. The apparatus of claim 11, wherein the smart routing engine is further configured to:
determine, using an intent determination model, a user intent parameter set based on the user activity log;
determine, based on the user intent parameter set, an intent associated with the user; and
determine, based on the user intent parameter set, a matched agent associated with the agent device.

13. The apparatus of claim 12, wherein a matching machine learning model determines the matched agent.

14. The apparatus of claim 13, wherein the communications hardware is further configured to receive, from the agent device or the user device, a match quality report, wherein the match quality report comprises a match quality indication,
wherein the smart routing engine further configured to train the matching machine learning model based on the match quality indication.

15. The apparatus of claim 12, wherein the smart routing engine is further configured to:
determine, based on the intent, a security score associated with the VoIP request; and
determine, based on the security score, a security action, wherein a VoIP initiation request is generated based on the security action.

16. The apparatus of claim 11, wherein the smart routing engine is further configured to generate, based on the agent device, a VoIP initiation request,
wherein the communications hardware further configured to provide the VoIP initiation request to a VoIP provider.

17. A computer program product for intelligent in-application calling, the computer program product comprising a non-transitory computer-readable storage medium storing instructions that, when executed by an apparatus, cause the apparatus to:
receive, from a user device, a user authentication request comprising authentication data associated with a user;
determine a user authentication result;
in response to determining a successful user authentication result, establish, an authenticated session with the user;
generate a user activity log, wherein the user activity log is updated to include an indication of activity during the authenticated session;
receive, during the authenticated session, a voice over internet protocol (VoIP) request, wherein the VoIP request comprises at least an indication of the user authentication result;
determine, based on the VoIP request and the user activity log, an agent device to connect with the user; and
establish a VoIP call between the user device and the agent device.

18. The computer program product of claim 17, wherein the instructions, when executed by the apparatus, further cause the apparatus to:
determine, using an intent determination model, a user intent parameter set based on the user activity log;
determine, based on the user intent parameter set, an intent associated with the user; and
determine, based on the user intent parameter set, a matched agent associated with the agent device.

19. The computer program product of claim 18, wherein a matching machine learning model determines the matched agent.

20. The computer program product of claim 19, wherein the instructions, when executed by the apparatus, further cause the apparatus to:
receive, from the agent device or the user device, a match quality report, wherein the match quality report comprises a match quality indication; and
train the matching machine learning model based on the match quality indication.
